(19) United States
(12) Patent Application Publication
(10) Pub. No.: US 2025/0050540 A1
(43) Pub. Date: Feb. 13, 2025

(54) MONOGUIDE MANUAL CUTTER

(71) Applicant: GERMANS BOADA, S.A., Rubi (ES)

(72) Inventors: David MARTINEZ GALINDO, Rubi (ES); Xavier SÁNCHEZ CASAS, Rubi (ES)

(21) Appl. No.: 18/930,413

(22) Filed: Oct. 29, 2024

Related U.S. Application Data
(63) Continuation of application No. PCT/ES2023/070115, filed on Mar. 1, 2023.

(51) Int. Cl. B28D 1/22

(52) U.S. Cl. CPC B28D 1/225

(57) ABSTRACT

A monoguide manual cutter is provided, which can comprise a base, a guide arranged longitudinally above the base, a carriage that can be moved along said guide and a tool holder mounted on the carriage and having a handle, a roller for marking a cutting line on the ceramic part and a blank holder for breaking said ceramic part along the cutting line. The aluminium extrusion guide comprises a cross-section with a narrow lower portion and a wider upper portion comprising longitudinal tracks for supporting and linearly moving rolling means of the carriage. The configuration of the guide can make it easier for the operator to view the roller while using the cutter.

### CROSS-REFERENCE TO RELATED APPLICATION(S)

This application is a continuation of International Patent Application No. PCT/ES2023/070115, filed Mar. 1, 2023, the entire disclosure of which is incorporated herein by reference.

### FIELD

The present disclosure relates to monoguide manual cutters used in construction for cutting ceramic cladding parts.

### BACKGROUND

Manual ceramic cutters generally comprise a base provided with a surface for positioning the ceramic part to be cut, and a tool holder that can be moved longitudinally by guiding means and provided with a drive handle, a roller or cutting tool for marking a cutting line on the ceramic part to be cut and a blank holder for breaking said part along the cutting line previously marked by the roller.

The tool holder guiding means may consist of two parallel guides or, as in the case of the cutter of the present invention, a single longitudinal guide.

Different types of monoguide manual cutters are known in the state of the art; for example, the cutters described in utility models ES1 067 012U, ES1 062 584U and ES 1 069 449U, all of them from the same applicant of the present invention.

One of the drawbacks of this type of manual monoguide cutters is the poor visibility of the roller that the operator has while using the cutter, due in part to the arrangement of the roller, the tool holder and the guide in the same vertical plane and, on the other hand, to the configuration of these elements.

This drawback is significantly aggravated when an aluminium guide is used instead of a steel one to improve portability, since the aluminium guide requires a much larger cross section to provide the same rigidity as a steel one.

An additional drawback is the risk of wear and deterioration of the aluminium guide due to friction of the tool holder when the cutter is under intensive use.

Another drawback of this type of cutter is the low power for separating or breaking the ceramic parts along the cutting line by means of the blank holder, since in order to take advantage of the leverage provided by the handle, the axis of rotation of the blank holder must be as close as possible to the axis of rotation of the tool holder, and the fact that there is only one guide and that the axis of rotation of the tool holder is located below the guide, limits said approximation.

### SUMMARY

The technical problem that arises is to overcome the drawbacks associated with the solutions known in the state of the art, by providing a monoguide manual cutter, with an aluminium guide, a movable carriage and a tool holder that make it easier for the operator to view the cutting tool while using the cutter.

Another objective of the present invention is to provide a guiding of the carriage on the aluminium guide that does not cause premature wear and deterioration of said guide.

Another objective of the invention is to increase the power of separation or breaking of the ceramic parts by the cutting line.

The monoguide manual cutter object of this invention is of the type described in the preamble of the independent claim, and which comprises: a base for supporting the ceramic parts to be cut, a guide arranged longitudinally above the base, a carriage that can be moved along said guide and a tool holder mounted on the carriage able to be rotated with respect to an axis perpendicular to the guide and which has a drive handle, a roller for marking a cutting line on the ceramic part and a blank holder for separating or breaking said ceramic part along the cutting line.

This cutter has technical features, included in the attached claims, which allow the aforementioned objectives to be achieved.

### BRIEF DESCRIPTION OF THE DRAWINGS

As a complement to the description provided herein, and for the purpose of helping to make the features of the invention more readily understandable, the present specification is accompanied by a set of drawings which, by way of illustration and not limitation, represent the following:

FIG. 1 shows a perspective view of an exemplary embodiment of the monoguide manual cutter according to the invention.

FIGS. 2 and 3 show respective partial elevation views of the cutter with the tool holder in two angular positions in which the roller and the blank holder can be observed respectively in an operative position.

FIG. 4 shows a profile view of the guide, the carriage and tool holder selected by a vertical plane.

FIG. 5 shows a cross section of an exemplary embodiment of the cutter guide, and below said guide the cutting roller. In this figure, the user's line of sight of the roller has been marked, without interference, due to the configuration of the guide.

FIG. 6 shows a cross section of the carriage mounted on the guide.

FIG. 7 shows a perspective view of the carriage, with the cover vertically cross-sectioned by a longitudinal median plane, allowing observation of the rolling means mounted thereon.

### DETAILED DESCRIPTION

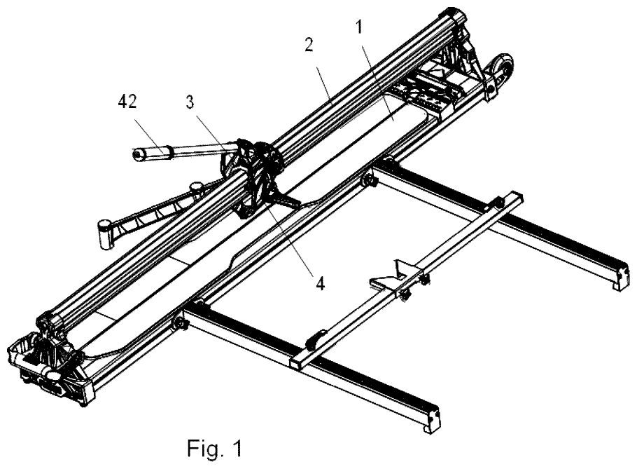

In the exemplary embodiment shown in FIG. 1, the monoguide manual cutter comprises a base (1) for supporting the ceramic parts to be cut, a guide (2) arranged longitudinally above the base (1), a carriage (3) that can be moved along the aforementioned guide (2) and a tool holder (4) mounted on the carriage (3) able to rotate with respect to an axis perpendicular to the guide (2).

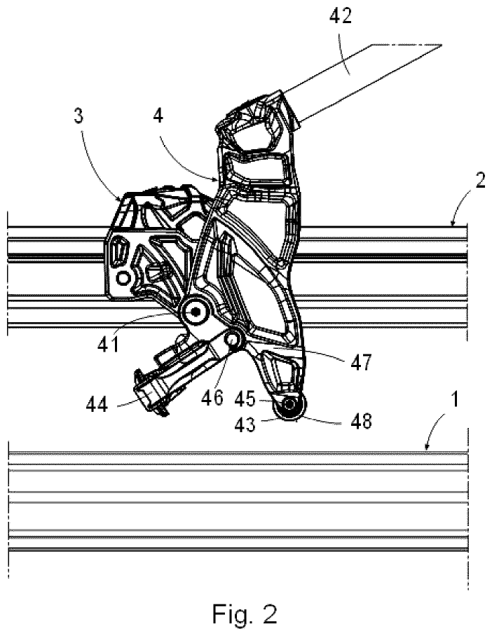

The aforementioned tool holder (4) has a drive handle (42) and, as shown in FIGS. 2 and 3, a roller (43) for marking a cutting line on a ceramic part (not shown) arranged on the base (1) and a blank holder (44) for subsequently breaking said ceramic part along the cutting line. The roller (43) and the blank holder (44) are mounted on the tool holder (4) by means of two rotation axes (45, 46).

The handle (42) allows the tool holder (4) to be rotated with respect to the axis of rotation (41) that connects the same to the carriage (3) to press the roller (43) against a ceramic part positioned on the base (1) and move the tool holder along the guide (2) marking a longitudinal cutting line on said ceramic part.

The handle (42) also allows the tool holder (4) to be rotated in the opposite direction to distance the roller (43) from the marked part and then press the blank holder (44), in the position shown in FIG. 3, against the previously marked ceramic part, causing it to break along the cutting line.

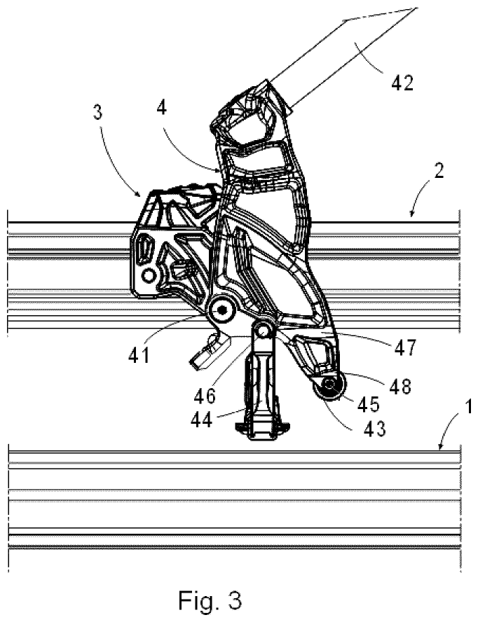

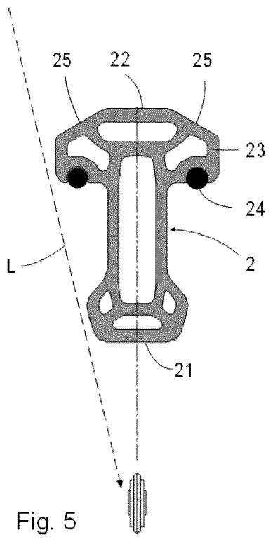

In FIGS. 4 to 6 the guide (2) of the aluminium extrusion cutter comprises a cross section with a narrow lower portion (21); and a wider upper portion (22).

In this specific embodiment the guide (2) has a general T-shaped configuration and comprises in the wider upper portion (22) lateral wings (23) and longitudinal tracks (24, 25) for supporting and moving rolling means of the carriage (3).

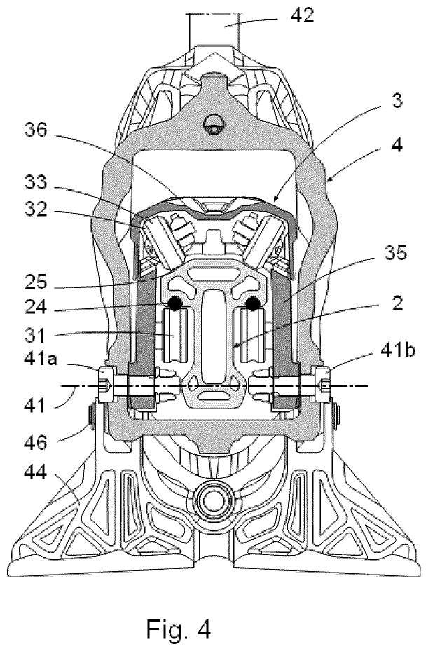

As shown in FIG. 5, the configuration of the guide (2), which is narrow at the bottom, makes it easier for the operator to view the roller (43) when using the cutter, since the guide (2) does not interrupt the line of vision (L).

This feature of the guide (2), in addition to improving the user's comfort of use of the cutter, allows a greater precision to be achieved in the placement of the ceramic part in relation to the roller and therefore a greater precision in the cut.

The longitudinal tracks of the aluminium guide (2) are made up of two steel rails (24) inserted under the wings (23) of said guide (2) and by two oblique planes (25) defined at the upper end of the guide (2) and laterally inclined in opposite directions.

The rolling means of the carriage (3) on the guide (2) comprise rail bearings (31) facing the steel rails (24) of the guide (2) and self-adjusting bearings (32) provided with a plastic outer sleeve (33) and facing the oblique planes (24) of the guide 2.

The incorporation of the aforementioned steel rails (24) in the guide (2) prevents the reaction forces, originated when pressing the roller (43) or the blank holder (44) against the ceramic part to be cut, and transmitted by the rail bearings (31) to the guide (2), from causing damage to the aluminium of said guide (2).

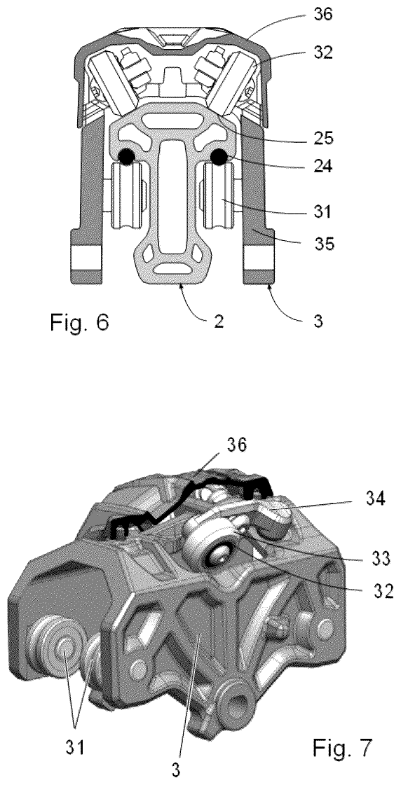

For its part, as shown in FIG. 7, the self-adjusting bearings (32) are mounted on two rocker arms (34) provided with an elastic element for self-adjusting the force applied by said self-adjusting bearings (32) on the oblique planes (25) of the guide (2). Said elastic element also contributes to the absorption of possible irregularities in the oblique planes (25) of the guide (2).

The longitudinal tracks formed by the steel rails (24) and by the oblique planes (25), and the rail bearings (31) and the self-adjusting bearings (32) are arranged respectively in the upper portion of the guide (2) and in the upper portion of the carriage (3) and spaced from the narrow lower portion of the guide; all this with the purpose of not constituting an obstacle in the line of vision (L) of the roller (43) by the operator.

The carriage (3) is made of cast aluminium and has an inverted U-shaped cross-section, with two lateral wings (35), which is open inferiorly, and arranged on the guide (2), embracing the same from above and laterally.

Said carriage (3) has a protective cover (36) made of aluminium at the top, which is shown cross-sectioned in FIG. 7, and which covers the self-adjusting bearings (32) and the respective rocker arms (34).

As shown in FIG. 2, the tool holder (4), made of cast aluminium, has an enveloping annular cross-section, arranged around the carriage (3) and the guide (2), and is attached to the lateral wings (35) of the carriage (3) by means of two independent semi-axes (41a, 41b), which form the axis of rotation (41) of the tool holder (4) with respect to the carriage (3).

Said semi-axes (41a, 41b) are aligned and arranged perpendicularly to the guide (2) in a horizontal plane located between the upper and lower ends of said guide.

The use of the aforementioned half-axes (41a, 41b) allows: the tool holder (4) to be moved on the guide (2), together with the carriage (3), without said half-axes (41a, 41b) interfering with the guide (2); the axis of rotation of the tool holder to be arranged in an elevated position, and the axis of rotation (46) of the blank holder (44) to be as close as possible to the axis of rotation (41) of the tool holder (4), in order to take advantage of the lever and exert a greater separation force with the blank holder (44) on the ceramic part.

As shown in FIGS. 2 and 3, the tool holder (4) comprises laterally, at the lower end opposite to the handle holder (42), extensions (47) oriented towards the rear area of the cutter taking as a reference the direction of advance of the tool holder during the marking of the ceramic part; said extensions (47) ending in a rear end (48) carrying the axis of rotation (45) of the roller (43) and distanced from the axis of rotation (41) of the tool holder (4).

Advantageously, the axis of rotation (46) of the blank holder (44) is arranged between the axis of rotation (45) of the roller (43) and the axis of rotation (41) of the tool holder (4), so that in the operative position of the blank holder (44), shown in FIG. 3, said axis of rotation (46) is arranged close to a vertical plane coinciding with the axis of rotation (41) of the tool holder (4), maximising the breaking force of the ceramic part applied to the handle (42) and transmitted by the blank holder (44) to the ceramic part.

Having sufficiently described the nature of the invention, in addition to a preferred exemplary embodiment, it is hereby stated for the relevant purposes that the materials, shape, size and layout of the described elements may be modified, provided that it does not imply altering the essential features of the invention claimed below.

1. A monoguide manual cutter, comprising:
a base for supporting a ceramic part to be cut;
a guide arranged longitudinally above the base;
a carriage configured to be moved along said guide and a tool holder mounted on the carriage able to rotate with respect to an axis perpendicular to the guide and having a drive handle;
a roller for marking a cutting line on the ceramic part and a blank holder for breaking said ceramic part along the cutting line;
wherein the guide is an aluminium extrusion guide having a cross-section with a narrow lower portion and a wider upper portion; and
wherein the wider upper portion comprises longitudinal tracks configured to support a linear roller of the carriage.

2. The monoguide manual cutter of claim 1, wherein the guide has a cross-section with a general T-shaped configuration, with two lateral wings at the wider upper portion.

3. The monoguide manual cutter of claim 2, wherein the longitudinal tracks of the guide comprise two steel rails inserted under the two lateral wings of said guide and two respective oblique planes defined at an upper end of the guide and laterally inclined in opposite directions.

4. The monoguide manual cutter of claim 3, wherein the linear roller of the carriage comprises:
rail bearings facing the steel rails of the guide; and
self-adjusting bearings provided with a plastic outer sleeve and facing the oblique planes of the guide.

5. The monoguide manual cutter of claim 4, wherein the self-adjusting bearings are mounted on respective rocker arms provided with an elastic element for self-adjusting force applied on the oblique planes of the guide and for absorbing irregularities of the oblique planes of the guide.

6. The monoguide manual cutter of claim 1, wherein the carriage, made of cast aluminium, comprises an inverted U-shaped cross-section, with two lateral wings, which is open inferiorly, and arranged on the guide.

7. The monoguide manual cutter of claim 6, wherein the carriage comprises an upper protective cover made of aluminium.

8. The monoguide manual cutter of claim 1, wherein the tool holder, made of cast aluminium, has an annular cross-section arranged around the carriage and the guide.

9. The monoguide manual cutter of claim 1, wherein the axis of rotation of the tool holder comprises two independent semi-axes of rotation mounted on lateral wings of the carriage, perpendicular to the guide and arranged in a horizontal plane located between upper and lower ends of said guide.

10. The monoguide manual cutter of claim 1, wherein the tool holder laterally comprises at its lower end two extensions oriented towards a rear area of the cutter and ending in a rear end carrying the axis of rotation of the roller and spaced from the axis of rotation of the tool holder.

11. The monoguide manual cutter of claim 10, wherein the axis of rotation of the blank holder is arranged between the axis of rotation of the roller and the axis of rotation of the tool holder, and that in an operative position of the blank holder said axis of rotation is arranged close to a vertical plane coinciding with the axis of rotation of the tool holder.
